(19) United States
(12) Patent Application Publication
(10) Pub. No.: US 2020/0391653 A1
(43) Pub. Date: Dec. 17, 2020

(54) SYSTEMS AND METHODS FOR AUTOMATIC VEHICLE TAIL LIGHTS

(71) Applicant: VISTEON GLOBAL TECHNOLOGIES, INC., Van Buren Township, MI (US)

(72) Inventor: Hari-hara-sudhan Karunai-Ramanujam, Canton, MI (US)

(21) Appl. No.: 16/440,396

(22) Filed: Jun. 13, 2019

(51) Int. Cl. B60Q 1/08; B60Q 9/00

(52) U.S. Cl. CPC B60Q 1/08; B60Q 2300/114; B60Q 2300/142; B60Q 9/008

(57) ABSTRACT

A light system may be provided for a vehicle. The light system may include a light source for signaling a surrounding vehicle, a communication device for communicating with the surrounding vehicle, and a controller coupled to the light source and the communication device. The communication device may receive a vehicle information message from the surrounding vehicle. Based on the vehicle information message, the controller may determine at least one of a velocity and an acceleration rate of the surrounding vehicle, analyze the at least one of the velocity and the acceleration rate to determine a default state or an impact condition, and when the impact condition is determined, automatically activate the light source to signal the surrounding vehicle.

### FIELD

This disclosure relates to vehicle tail lights, and in particular, automatic vehicle tail lights.

### RELATED ART

A conventional vehicle requires a driver to press a brake pedal to turn on rear brake lights of the vehicle. The rear brake lights, when on, may warn a driver of another vehicle that the conventional vehicle is braking. When the driver stops pressing the brake pedal, the brake lights turn off. Thus, in the conventional vehicle, the rear brake lights are dependent on the driver.

In the conventional vehicle, the rear brake lights are limited to indicating whether braking is occurring. However, the conventional vehicle could slow for other reasons. For example, when the conventional vehicle is equipped with a manual transmission, downshifting from a high gear to a low gear may slow the conventional vehicle. The conventional vehicle, however, would not report out that change to surrounding vehicles or persons, such as through a light system. For example, because the rear brake lights are only limited to actions associated with the brake pedal, purely downshifting would not turn on the rear brake lights, even though the conventional vehicle may be slowing, like when braking.

### SUMMARY

This disclosure relates generally to systems and methods for automatic vehicle tail lights.

An aspect of the disclosed embodiments includes a light system for a vehicle. The light system may include a light source for signaling a surrounding vehicle. For example, through the light source, the vehicle may signal the surrounding vehicle to slow down. The surrounding vehicle may include a sensor, such as a camera, to detect the light source and/or an operational state thereof. The light source may be one or more rear lights on the vehicle. For example, the light source may be a tail light of the vehicle or a brake light of the vehicle. In relation to the vehicle, the surrounding vehicle may trail the vehicle. As such, the surrounding vehicle may be considered a trailing vehicle. Additionally, the vehicle may be an ego-vehicle.

The light system may include a communication device for communicating with the surrounding vehicle. For example, the communication device may include a receiver, a transmitter, and/or a transceiver. The communication device may receive a vehicle information message from the surrounding vehicle. The vehicle information message may include position information associated with the surrounding vehicle. The position information may also be referred to as location information. The light system may include a controller coupled to the light source and the communication device. The controller may determine at least one of a velocity and an acceleration rate of the surrounding vehicle from the vehicle information message. The controller may analyze the at least one of the velocity and the acceleration rate to determine a default state or an impact condition. The impact condition may be a prediction that the surrounding vehicle is likely to physically contact the vehicle. Conversely, the default state may be a prediction that the surrounding vehicle is unlikely to contact the vehicle. When the impact condition is determined, the controller may automatically activate the light source to signal the surrounding vehicle. This may trigger the surrounding vehicle to slow down or alter course, such as change lanes. The automatic activation is not dependent on an occupant, such as a driver, in the vehicle.

Another aspect of the disclosed embodiments includes a light system for a vehicle. The light system may include a light source attached to the vehicle. The light source may be located in a rear portion of the vehicle. The light system may include a communication device on-board the vehicle. The communication may receive a vehicle information message from a surrounding vehicle. The light system may include a controller coupled to the light source and the communication device. The controller may determine a velocity and an acceleration rate of the surrounding vehicle from the vehicle information message. The controller may analyze the velocity and the acceleration rate to determine a prediction on whether the surrounding vehicle is likely to physically contact the vehicle. When the prediction is that the surrounding vehicle is likely to physically contact the vehicle, the controller may automatically activate the light source to signal the surrounding vehicle, such as to warn the surrounding vehicle of the prediction. This may trigger the surrounding vehicle to slow down or alter course, such as change lanes.

The communication device may receive a second vehicle information message from the surrounding vehicle, as well as additional vehicle information messages beyond the second vehicle information message. Based on the second vehicle information message, the controller may determine whether the velocity of the surrounding vehicle has increased, decreased, or remained the same. This may be by comparing the velocity to a second velocity determined from the second vehicle information message. Similarly, based on the second vehicle information message, the controller may determine whether the acceleration rate of the surrounding vehicle has increased, decreased, or remained the same. This may be by comparing the acceleration rate to a second acceleration rate determined from the second vehicle information message. Through the comparison of the velocity and the second velocity, and the comparison of the acceleration and the second acceleration rate, the controller may determine whether the surrounding vehicle has made any adjustments to dynamics in response to the light source. For example, the surrounding vehicle may have reduced its speed or altered its course. Alternatively, for example, the surrounding vehicle may have taken no action in response to the light source or even increased its speed without changing course.

As such, the controller may determine whether the prediction is more probable, less probable, or the same. This may be based on a comparison of the prediction and a second prediction determined from the second vehicle information message. If the prediction based on the vehicle information message was a likelihood of physical contact, and based on the second vehicle information, that prediction has either increased or remained the same, the controller may cause the vehicle to accelerate to a higher speed or alter course, in order for the probability of the prediction to drop below a threshold, such as fifty percent.

For example, the controller may issue a request to an advanced driver assistance system (ADAS), such as an autonomous drive system on-board the vehicle, to increase the speed of the vehicle or alter course of the vehicle. The request may be time sensitive. As such, the ADAS may determine whether to accept the request in under a short amount of time, such as one second. The ADAS may determine whether any objects may be present in front of the vehicle, which may limit the ability to accelerate to the higher speed. This may be via a sensor on the front of the vehicle, such as a camera or a LIDAR sensor. The ADAS may determine whether any additional lanes are present on either side of the vehicle. This may be through a positioning system on-board the vehicle, which includes a map database and is able to determine the position of the vehicle in relation to the map database, such as what the lane the vehicle is in on a road and whether the road has any additional lanes in relation to the position of the vehicle. The ADAS may further determine whether any objects may be present in one or more lanes next to the vehicle, which may limit the ability to alter course. This may be through a sensor, such as a camera or a LIDAR sensor. Additionally or alternatively, the controller may be able to determine whether an object may be located either in front of the vehicle or along a side of the vehicle, based on whether the communication device received any messages having position information associated with object(s). The ADAS may verify whether the controller's determination on presence or lack of presence of objects is correct.

The ADAS may determine whether to accept the request from the controller. If accepted, the ADAS may carry out the requested action. If denied, the ADAS may inform the controller of the reason for the denial—such as, object present in front of the vehicle which limits the ability to accelerate to the higher speed, no additional lanes present to alter course, or object present in additional lane. The controller may instruct the communication device to transmit an emergency message out to object(s) around the vehicle and/or the surrounding vehicle. For example, the emergency message may request an object to increase speed or alter course. The emergency message may further include an explanation for the request, such as the prediction of the likelihood of physical contact by the surrounding vehicle to the vehicle. The emergency message may be time sensitive. The communication device may receive a response message from the object whether the object accepts the request. Based on the response message, the controller may reissue the request to ADAS. As another example, the emergency message may request the surrounding vehicle to decrease speed or alter course.

Based on the prediction, the controller may request an audio system in the vehicle to generate an audible warning for an occupant in the vehicle. Similarly, based on the prediction, the controller may request a display to show a visual warning for the occupant in the vehicle.

Another aspect of the disclosed embodiments includes a non-transitory computer-readable medium. The non-transitory computer readable medium may be encoded with instructions that, when executed in hardware, such as by a processor, may perform a process. The process may include receiving, at a first vehicle, a vehicle information message from a second vehicle. The process may include determining a velocity or acceleration of the second vehicle based on the received vehicle information message. The process may include activating at least one rear light source of the first vehicle based on the determined velocity or acceleration.

Another aspect of the disclosed embodiments includes an apparatus. The apparatus includes at least one arithmetic logic unit and at least one memory unit including computer program instructions, which may be configured to cause the apparatus at least to receive, at a first vehicle, a vehicle information message from a second vehicle. The at least one arithmetic logic unit and at least one memory unit may also be configured to cause the apparatus at least to, based on the received message, activate at least one tail light of the first vehicle.

Another aspect of the disclosed embodiments includes an apparatus. The apparatus includes at least one processor and at least one memory including computer program instructions. The at least one memory and the computer program instructions may be configured to, with the at least one processor, cause the apparatus at least to receive, at a first vehicle, a vehicle information message from a second vehicle. The at least one memory and the computer program instructions may also be configured to, with the at least one processor, cause the apparatus at least to, based on the received message, activate at least one tail light of the first vehicle.

Another aspect of the disclosed embodiment includes a non-transitory computer-readable medium encoded with instructions that, when executed in hardware, perform a process. The process may include receiving, at a first vehicle, a vehicle information message from a second vehicle. The process may also include, based on the received message, activating at least one tail light of the first vehicle.

Another aspect of the disclosed embodiments includes a method. The method includes receiving, at a first vehicle, a vehicle information message from a second vehicle. The method may also include, based on the received message, activating at least one tail light of the first vehicle.

### BRIEF DESCRIPTION OF THE DRAWINGS

The disclosure is best understood from the following detailed description when read in conjunction with the accompanying drawings. The various features of the drawings are not to-scale. On the contrary, the dimensions of the various features are arbitrarily expanded or reduced for clarity.

FIG. 1 generally illustrates a trailing vehicle and a preceding vehicle, according to the principles of the present disclosure.

FIG. 2 generally illustrates a light system for a vehicle according to the principles of the present disclosure.

FIG. 3 generally illustrates a method according to the principles of the present disclosure.

FIG. 4 generally illustrates a system according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

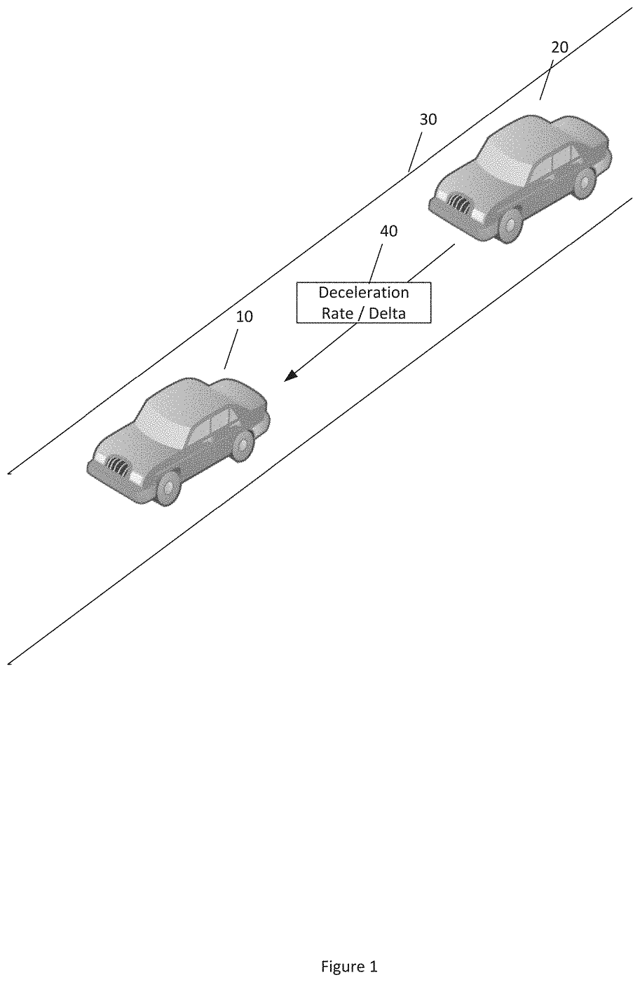

FIG. 1 generally illustrates a trailing vehicle and a preceding vehicle, according to one or more embodiments. As shown in FIG. 1, a first vehicle 10 may receive a vehicle information message 40 from a second vehicle 20. Both vehicles 10, 20 may be traveling on a same road 30 in a same direction. Based on the received message 40, the first vehicle 10 may activate at least one tail light of the first vehicle 10.

The activating at least one tail light may include activating a pair of rear brake lights. Other brake lights may also be activated, such as brake lights in a rear window, in a spoiler, on a trunk, on side mirrors, or the like.

The first vehicle 10 may also determine a velocity or acceleration of the second vehicle 20 based on the received message. For example, the velocity or acceleration may be directly expressed in the message 40 or may be inferred from position information (and optionally time information) in the message 40 in conjunction with, for example, an earlier position message (not shown) from the same vehicle, namely second vehicle 20. The activating the at least one tail light may be based on the determined velocity or acceleration.

The velocity or acceleration of the second vehicle 20 may be determined relative to the first vehicle 10. For example, the second vehicle 20 may provide (to the first vehicle 10) a velocity or acceleration with respect to a surface of road 30. The first vehicle 10 may then calculate relative velocity or acceleration based on that information. For example, the relative velocity of the second vehicle 20 may be calculated by subtracting the velocity of the second vehicle 20 with respect to road 30 from the velocity of the first vehicle 10 with respect to road 30. Relative acceleration can be similarly calculated by subtracting the acceleration of the second vehicle 20 with respect to road 30 from the acceleration of the first vehicle 10 with respect to road 30. Alternatively, the second vehicle 20 may calculate the relative velocity and provide the relative velocity in the message 40.

The first vehicle 10 may further be configured to predict a potential collision between the second vehicle 20 and the first vehicle 10. The activating the at least one tail light may be based on the predicted potential collision. For example, the activating the at least one tail light may occur when the predicted potential collision has at least a threshold percentage likelihood of occurring. The threshold may be selected to optimize between safety and courtesy.

One or more embodiments relate to concepts and technologies that may be used to switching on the tail lights of a moving vehicle automatically. More particularly, one or more embodiments relate to concepts and technologies to switch on the tail lights of a vehicle without the intervention of the vehicle's driver. Thus, for example, the vehicle may not require any action by the driver. The same principles may be applied to fully or partially autonomous vehicles, as no human may need to be directly involved. For example, the vehicle may autonomously activate the lights of the vehicle based on, for example, the rate of decelerating distance between the vehicle itself, and another vehicle that is traveling in the same direction as the vehicle but behind the vehicle. This information regarding relative velocity and/or relative deceleration may be calculated using location information from each vehicle, contained in V2X messages.

By automating tail lights of a preceding vehicle, based on the relative positional deceleration of the preceding vehicle and a trailing vehicle, an alert may be signaled, via the taillight of the preceding vehicle, to the trailing vehicle. The alert, for example, may warn a driver or an autonomous system of the trailing vehicle of a potential rear-end collision. Because of the alert, the trailing vehicle, via the driver or the autonomous system, may prevent the potential rear-end collision or otherwise minimize the potential rear-end collision. Even in autonomous modes, the tail lights may add value to a sensor in detecting a relatively slowly moving vehicle. For example, a camera in the trailing vehicle may detect the increased light intensity of the tail lights and consequently may favor a lower speed estimate for the vehicle.

Various communication protocols may be used. For example, vehicle to everything (V2X) messages may carry location information of every vehicle in which V2X protocols are operational. These messages may be transmitted over the air to nearby vehicles. Thus, using the location of a vehicle that is travelling in a straight line of path behind a host vehicle (sometimes also referred to as the ego vehicle), the relative velocity and acceleration rate may be calculated in view of the relative position of both the vehicles. An automatic danger light, tail light, or other warning light may be turned on to warn the remote vehicle of a potential collision. The activation of this warning light (for example, automatic danger light, tail light, or other warning light) may be accompanied by the transmission of a warning V2X message, which may also suggest braking to the trailing car.

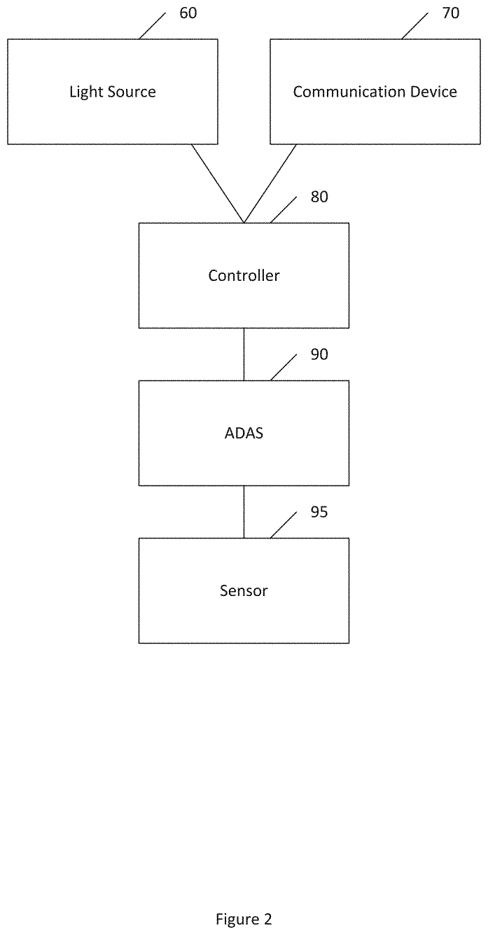

FIG. 2 generally illustrates a light system for a vehicle according to one or more embodiments. The light system may include a light source 60 attached to the vehicle. The light source 60 may be located in a rear portion of the vehicle. The light system may include a communication device 70 on-board the vehicle. The communication may receive a vehicle information message from a surrounding vehicle (see, for example, second vehicle 20 in FIG. 1). The light system may include a controller 80 coupled to the light source 60 and the communication device 70. The controller 80 may determine a velocity and an acceleration rate of the surrounding vehicle from the vehicle information message. The controller 80 may analyze the velocity and the acceleration rate to determine a prediction on whether the surrounding vehicle is likely to physically contact the vehicle. When the prediction is that the surrounding vehicle is likely to physically contact the vehicle, the controller 80 may automatically activate the light source 60 to signal the surrounding vehicle, such as to warn the surrounding vehicle of the prediction. This may trigger the surrounding vehicle to slow down or alter course, such as change lanes.

The communication device 70 may receive a second vehicle information message from the surrounding vehicle, as well as additional vehicle information messages beyond the second vehicle information message. Based on the second vehicle information message, the controller 80 may determine whether the velocity of the surrounding vehicle has increased, decreased, or remained the same. This may be by comparing the velocity to a second velocity determined from the second vehicle information message. Similarly, based on the second vehicle information message, the controller 80 may determine whether the acceleration rate of the surrounding vehicle has increased, decreased, or remained the same. This may be by comparing the acceleration rate to a second acceleration rate determined from the second vehicle information message. Through the comparison of the velocity and the second velocity, and the comparison of the acceleration rate and the second acceleration rate, the controller 80 may determine whether the surrounding vehicle has made any adjustments to dynamics in response to the light source 60. For example, the surrounding vehicle may have reduced its speed or altered its course. Alternatively, for example, the surrounding vehicle may have taken no action in response to the light source 60 or even increased its speed without changing course.

Taking such data into account, the controller 80 may determine whether the prediction is more probable, less probable, or the same. This may be based on a comparison of the prediction and a second prediction determined from the second vehicle information message. If the prediction based on the vehicle information message was a likelihood of physical contact, and based on the second vehicle information, that prediction has either increased or remained the same, the controller 80 may cause the vehicle to accelerate to a higher speed or alter course, in order for the probability of the prediction to drop below a threshold, such as fifty percent.

For example, the controller 80 may issue a request to an advanced driver assistance system (ADAS) 90, such as an autonomous drive system on-board the vehicle, to increase the speed of the vehicle or alter course of the vehicle. The request may be time sensitive. As such, the ADAS 90 may determine whether to accept the request in under a short amount of time, such as one second. This timing value could be a variable value based on the deceleration and/or distance delta between the vehicle itself and the second vehicle. The ADAS 90 may determine whether any objects may be present in front of the vehicle, which may limit the ability to accelerate to the higher speed. This may be via a sensor 95, such as a camera or a LIDAR sensor. Sensor 95 may be located on the front of the vehicle, on top of the vehicle, or in other places. The ADAS 90 may determine whether any additional lanes are present on either side of the vehicle. This may be through a positioning system on-board the vehicle, which includes a map database and is able to determine the position of the vehicle in relation to the map database, such as what the lane the vehicle is in on a road and whether the road has any additional lanes in relation to the position of the vehicle. The ADAS 90 may further determine whether any objects may be present in one or more lanes next to the vehicle, which may limit the ability to alter course. This may likewise be through sensor 95 (or another similar sensor), which may be a camera or a LIDAR sensor. Additionally or alternatively, the controller 80 may be able to determine whether an object may be located either in front of the vehicle or along a side of the vehicle, based on whether the communication device 70 received any messages having position information associated with object(s). The ADAS 90 may verify whether the determination by the controller 80 on presence or lack of presence of objects is correct.

The ADAS 90 may determine whether to accept the request from the controller 80. If accepted, the ADAS 90 may carry out the requested action. If denied, the ADAS 90 may inform the controller 80 of the reason for the denial—such as, object present in front of the vehicle which limits the ability to accelerate to the higher speed, no additional lanes present to alter course, or object present in additional lane. The controller 80 may instruct the communication device 70 to transmit an emergency message out to object(s) around the vehicle and/or the surrounding vehicle. For example, the emergency message may request an object to increase speed or alter course. The emergency message may further include an explanation for the request, such as the prediction of the likelihood of physical contact by the surrounding vehicle to the vehicle. The emergency message may be time sensitive. A V2X message may be broadcasted every 100 ms. This rate may be changed (for example, to a lower number of milliseconds) based on an emergent situation such as a predicted collision or incursion. The communication device 70 may receive a response message from the object whether the object accepts the request. Based on the response message, the controller 80 may reissue the request to ADAS 90. As another example, the emergency message may request the surrounding vehicle to decrease speed or alter course.

Based on the prediction, the controller 80 may request an audio system in the vehicle to generate an audible warning for an occupant in the vehicle. Similarly, based on the prediction, the controller 80 may request a display to show a visual warning for the occupant in the vehicle.

One or more embodiments may include a non-transitory computer-readable medium. The non-transitory computer readable medium may be encoded with instructions that, when executed in hardware, such as by a processor, may perform a process. The process may include receiving, at a first vehicle, a vehicle information message from a second vehicle. The process may include determining a velocity or acceleration of the second vehicle based on the received vehicle information message. The process may include activating at least one rear light source 60 of the first vehicle based on the determined velocity or acceleration.

According to one or more embodiments, an apparatus may include at least one arithmetic logic unit and at least one memory unit including computer program instructions, which may be configured to cause the apparatus at least to receive, at a first vehicle, a vehicle information message from a second vehicle. The at least one arithmetic logic unit and at least one memory unit may also be configured to cause the apparatus at least to, based on the received message, activate at least one tail light of the first vehicle.

In one or more embodiments, an apparatus may include at least one processor and at least one memory including computer program instructions. The at least one memory and the computer program instructions may be configured to, with the at least one processor, cause the apparatus at least to receive, at a first vehicle, a vehicle information message from a second vehicle. The at least one memory and the computer program instructions may also be configured to, with the at least one processor, cause the apparatus at least to, based on the received message, activate at least one tail light of the first vehicle.

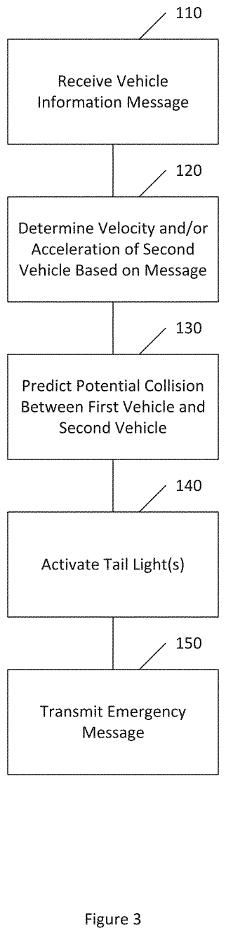

FIG. 3 generally illustrates a method according to one or more embodiments. As shown in FIG. 3, a method may include, at 110, receiving, at a first vehicle, a vehicle information message from a second vehicle. The vehicle information message may be a vehicle to everything (V2X) message.

The method may further include, at 140, based on the received message, activating at least one tail light of the first vehicle. The activating at least one tail light may include activating a pair of rear brake lights. Other lights may also be activated, such a center light in a rear window, on a spoiler, on a trailer hitch, or in any other desired location.

The method may also include, at 150, a controller instructing a communication device to transmit an emergency message out to object(s) around the vehicle and/or the surrounding vehicle. For example, the emergency message may request an object to increase speed or alter course. The emergency message may further include an explanation for the request, such as the prediction of the likelihood of physical contact by the surrounding vehicle to the vehicle. The emergency message may be time sensitive.

The method may also include, at 120, determining a velocity or acceleration of the second vehicle based on the received message. The activating may be based on the determined velocity or acceleration. The velocity or acceleration may be determined relative to the first vehicle.

The method may further include, at 130, predicting a potential collision between the second vehicle and the first vehicle. The activating may be based on the predicted potential collision. The activating may occur when the predicted potential collision has at least a threshold percentage likelihood of occurring.

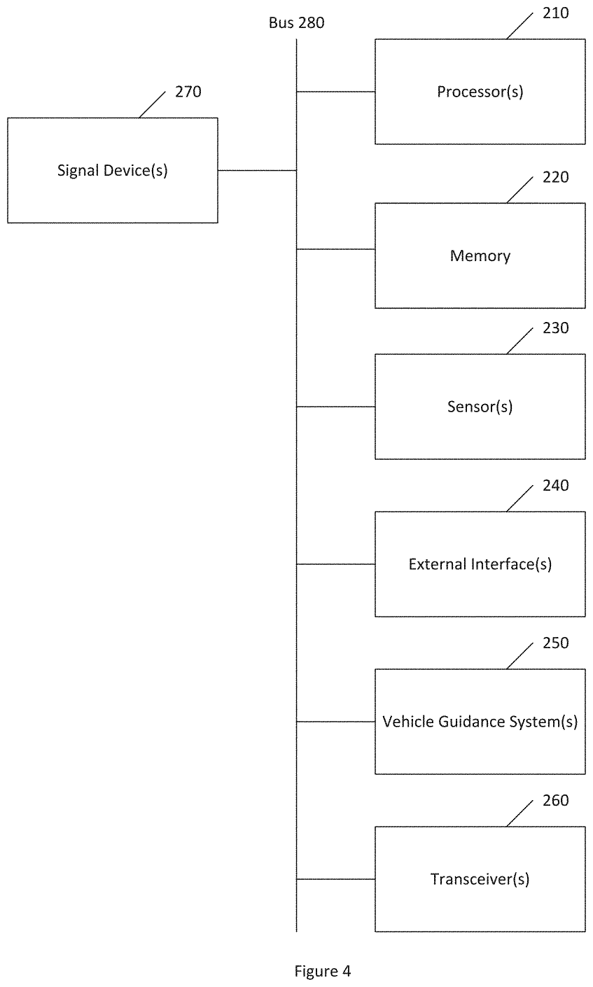

FIG. 4 generally illustrates a system according to one or more embodiments. The system illustrated in FIG. 4 may be embodied in a vehicle or in one or more components of a vehicle. For example, one or more embodiments may be implemented as an electronic control unit (ECU) of a vehicle.

The system may include one or more processors 210 and one or more memories 220. The processor 210 and memory 220 may be embodied on a same chip, on different chips, or otherwise separate or integrated with one another. The memory 220 may be a non-transitory computer-readable memory. The memory 220 may contain a set of computer instructions, such as a computer program. The computer instructions, when executed by the processor 210, may perform a process, such as the method shown in FIG. 3, or any of the other methods disclosed herein.

The processor 210 may be one or more computer chips including one or more processing cores. The processor 210 may be an application specific integrated circuit (ASIC) or a field programmable gate array (FPGA). The memory 220 may be a random access memory (RAM) or a read only memory (ROM). The memory 220 may be a magnetic medium, an optical medium, or any other medium.

The system may also include one or more sensors 230. The sensors 230 may include devices that monitor the position of the vehicle or surrounding vehicles. Devices may include, for example, global positioning system (GPS) or the like. The sensors 230 may include cameras (visible or infrared), ultrasonic sensors, or the like.

The system may also include one or more external interfaces 240. The external interface 240 may be a wired or wireless connection to a device that is not itself a component of the vehicle. Such devices may include, for example, smart phones, smart watches, personal digital assistants, smart pedometers, fitness wearable devices, smart medical devices, or any other portable or wearable electronics.

The system may also include one or more vehicle guidance systems 250. The vehicle guidance system 250 may include its own sensors, interfaces, and communication hardware. For example, the vehicle guidance system 250 may be configured to permit fully autonomous, semi-autonomous, and manual driving. The vehicle guidance system 250 may be able to assume steering control, throttle control, traction control, braking control, and other control from a human driver. The vehicle guidance system 250 may be configured to operate in conjunction with an advanced driver awareness system, which may have features such as automatic lighting, adaptive cruise control and collision avoidance, pedestrian crash avoidance mitigation (PCAM), satnav/traffic warnings, lane departure warnings, automatic lane centering, automatic braking, and blind-spot mitigation.

The system may further include one or more transceivers 260. The transceiver 260 may be a Wi-Fi transceiver, a V2X transceiver, or any other suitable wireless transceiver, such as a satellite or cellular communications transceiver.

The system may further include signal devices 270. The signal device 270 may be configured to provide an audible warning (such as a siren or honking noise) or a visual warning (such as flashing or strobing lights). The signal device 270 may be provided by a vehicle's horn and/or headlights and taillights. Other signals are also permitted.

The signal device 270, transceiver 260, vehicle guidance system 250, external interface 240, sensor 230, memory 220, and processor 210 may be variously communicably connected, such as via a bus 280, as shown in FIG. 4. Other topologies are permitted. For example, the use of a Controller Area Network (CAN) is permitted.

In one or more embodiments, the trigger may be related to the vehicle itself or the environment. Accordingly, in one or more embodiments the tail lights may be automatically illuminated every time the vehicle has a deceleration greater than a predetermined threshold, or every time visibility drops below a predetermined threshold. For example, a vehicle may slow because of a change in gears or change in road conditions (for example, muddy or hilly conditions may slow a vehicle). Likewise, blizzard or fog conditions may serve as triggers to illuminate the tail lights, optionally with a blinking pattern.

Likewise, a vehicle may sense a local speed limit and may optionally trigger the tail lights whenever a vehicle is travelling a predetermined threshold below the speed limit. The predetermined threshold may be an amount of speed (for example, 10 miles per hour) or a percentage (for example, 20 percent). The predetermined threshold may further be based on a detected lane of travel. For example, when the vehicle detects itself to be in a passing lane (for example, the left-most lane in a United States highway), the threshold may be lower than when then the vehicle detects itself to be in one of the other lanes. Other triggers for the automatic tail lights are also permitted.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Various terms are used to refer to particular system components. In the above discussion and in the claims, the terms “including” and “comprising” are used in an open-ended fashion, and thus should be interpreted to mean “including, but not limited to . . . .” In addition, the term “couple” or “couples” is intended to mean either an indirect or a direct connection. Thus, if a first device couples to a second device, that connection may be through a direct connection or through an indirect connection via other devices and connections.

“Controller” may refer to individual circuit components, an application-specific integrated circuit (ASIC), a microcontroller with controlling software, a digital signal processor (DSP), a processor with controlling software, a field programmable gate array (FPGA), or combinations thereof.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation to encompass all such modifications and equivalent structure as is permitted under the law.

What is claimed is:

1. A light system for a vehicle, the light system comprising:
a light source for signaling a surrounding vehicle;
a communication device for communicating with the surrounding vehicle, the communication device is configured to receive a vehicle information message from the surrounding vehicle; and
a controller coupled to the light source and the communication device, the controller is configured to:
determine at least one of a velocity and an acceleration rate of the surrounding vehicle from the vehicle information message;
analyze the at least one of the velocity and the acceleration rate to determine a default state or an impact condition; and
when the impact condition is determined, automatically activate the light source to signal the surrounding vehicle.

2. The light system of claim 1, wherein the communication device is configured to support at least one of cellular vehicle-to-everything (C-V2X) communications and dedicated short-range communications (DSRC).

3. The light system of claim 1, wherein the communication device is a vehicle-to-everything (V2X) communication device.

4. The light system of claim 1, wherein the communication device includes a first integrated circuit for C-V2X communications and a second integrated circuit for DSRC.

5. The light system of claim 1, wherein the communication device is configured to receive the vehicle information message as a wireless message.

6. The light system of claim 1, wherein the communication device is configured to receive position information associated with the surrounding vehicle as part of the vehicle information message.

7. The light system of claim 6, wherein the controller is configured to determine the at least one of the velocity and the acceleration rate based on the position information of the surrounding vehicle.

8. The light system of claim 1, wherein the controller is configured to determine a transition from the impact condition to the default state to automatically turn off the light source.

9. The light system of claim 8, wherein the impact condition is a prediction that the surrounding vehicle is likely to physically contact the vehicle, based on the at least one of the velocity and the acceleration rate of the surrounding vehicle.

10. The light system of claim 9, wherein the default state is a prediction that the surrounding vehicle is unlikely to physically contact the vehicle, based on the at least one of the velocity and the acceleration rate of the surrounding vehicle.

11. The light system of claim 1, wherein the light system is configured to receive a second vehicle information message from the surrounding vehicle to determine whether the at least one of the velocity and the acceleration rate of the surrounding vehicle has increased, decreased, or remained the same.

12. A light system for a vehicle, the light system comprising:
a light source attached to the vehicle;
a communication device on-board the vehicle and configured to receive a vehicle information message from a surrounding vehicle; and
a controller coupled to the light source and the communication device and configured to:
determine a velocity and an acceleration rate of the surrounding vehicle from the vehicle information message;
analyze the velocity and the acceleration rate to determine a prediction on whether the surrounding vehicle is likely to physically contact the vehicle; and
when the prediction is that the surrounding vehicle is likely to physically contact the vehicle, automatically activate the light source to warn the surrounding vehicle.

13. The light system of claim 12, wherein the communication device is configured to receive cellular vehicle-to-everything (C-V2X) communications and dedicated short-range communications (DSRC).

14. The light system of claim 12, wherein the controller is configured to determine the velocity and the acceleration rate based on position information of the surrounding vehicle from the vehicle information message.

15. The light system of claim 14, wherein the controller is configured to calculate a velocity delta based on a velocity of the vehicle and the velocity of the surrounding vehicle.

16. The light system of claim 15, wherein the controller is configured to calculate an acceleration delta based on an acceleration rate of the vehicle and the acceleration rate of the surrounding vehicle.

17. The light system of claim 16, wherein the controller is configured to receive the position information associated with the vehicle.

18. The light system of claim 17, wherein the controller is configured to determine the prediction based at least on the velocity delta, the acceleration delta, and the position information of the vehicle.

19. A non-transitory computer-readable medium encoded with instructions that, when executed in hardware, perform a process, the process comprising:
receiving, at a first vehicle, a vehicle information message from a second vehicle;
determining a velocity or an acceleration rate of the second vehicle based on the received vehicle information message; and
activating at least one rear light source of the first vehicle based on the determined velocity or acceleration rate.

20. The non-transitory computer-readable medium of claim 19, the process further comprising predicting whether the second vehicle is likely to physically contact the first vehicle based on the determined velocity or acceleration rate; wherein the activating the at least one rear light source occurs when the prediction has at least met a threshold percentage of likelihood of the second vehicle physically contacting the first vehicle.
